(19) United States
(12) Patent Application Publication
(10) Pub. No.: US 2013/0119767 A1
(43) Pub. Date: May 16, 2013

(54) POWER SUPPLY DEVICE WITH BACKUP POWER

(71) Applicant: Tang-Hsien HUANG, Taipei City (TW)

(72) Inventor: Tang-Hsien HUANG, Taipei City (TW)

(21) Appl. No.: 13/347,384

(22) Filed: Jan. 10, 2012

(30) Foreign Application Priority Data
Nov. 15, 2011 (TW) 100141669

(51) Int. Cl. H02J 9/00

(52) U.S. Cl. 307/66

(57) ABSTRACT

A power supply device with backup power is provided and comprises a main body having multiple power supply output wires; a power input socket being mounted on the main body; a power supply module mounted in the main body being electronically connected to the power supply output wires and the power input socket, and optionally outputting electric power from the power input socket or outputting backup power when the electrical grid is interrupted; a battery module mounted in the main body being electronically connected to the power supply module; and a charging circuit module mounted in the main body being electronically connected to the battery module and the power supply module.

### CROSS-REFERENCE TO RELATED APPLICATION

This application claims the benefit of Taiwan Patent Application No. 100141669, filed on Nov. 15, 2011, in the Taiwan Intellectual Property Office, the disclosure of which is incorporated herein in its entirety by reference.

### BACKGROUND OF THE INVENTION

1. Field of the Invention

The present invention relates to a power supply device with backup power, and more particularly to a power supply device combining power supply function with Uninterruptible Power Supply (UPS) system.

2. Description of the Related Art

Since electric technology is gradually developed and advanced and since office culture is changed, units, such as companies, factories, laboratories, etc, are aggressively introduced with electronic progress operation to replace complicated human-based manual operation under a traditional working status. Thus, it's common to utilize a system mainframe to provide an operation system in the units in which personnel works.

In the conventional technique, the system mainframe usually occupies larger spaces, and since the type of the system mainframe has higher importance, the host needs to be placed in an independent space. Consequently, the space allocation for offices and operational environments may be a problem. Generally, the system mainframe does not only equip with a power supply device that occupies a certain space, but also incorporates with a corresponding Uninterruptible Power Supply (UPS) system to prevent the mainframe from malfunctioning or losing data due to interrupted voltage. Therefore, the space utilization may be a great issue. Since there is no technique to effectively integrate the individually separated power supply device with the UPS system in markets, the defect may be produced. Therefore, the inventor of the present invention ponders and designs a power supply device with backup power to improve the defects of the conventional technique to further increase the utilization in industries.

The design of the power supply device according to the present invention is based on the change of the power supply mode in the conventional mainframe system under the main consideration of green energy promotion or energy costs. The supplied watts of most mainframe systems can be decreased to be below 100 watts from several hundred watts. Most buildings are widely equipped with backup power generators. Therefore, an objective of the present invention is focused on maintaining the power supply of the system for dozens of minutes when normal power supply is interrupted. The power supply can be taken as electricity during transition period after normal power supply is interrupted to prevent data from being lost to cause unexpected loss. The power supply for dozens of minutes is enough to allow the user to start the backup power generators in the building and is a design of auxiliary power supply in case of emergency.

In addition, since the conventional system is restricted in indoor space allocation, saving the space of arranging the UPS in the original restricted space to achieve the optimum benefits becomes an emphasis point in the invention.

### SUMMARY OF THE INVENTION

In view of the shortcomings of the prior art, the inventor(s) of the present invention based on years of experience in the related industry to conduct extensive researches and experiments, and finally developed a power supply device with backup power as a principle objective to overcome a difficulty of conventional techniques.

To achieve the foregoing objective of the invention, a power supply device with backup power is provided as the technique means of the invention and includes a main body, a power input socket, a power supply module, a battery module and a charging circuit module. The main body is a case having a circuit space therein, and the main body is further disposed with a plurality of power supply output wires. The power input socket is a connection socket for being plugged with a power line to allow a plug of the power line to be fed with alternating current of an electrical grid. The power input socket is correspondingly disposed on the main body, and a slot of the power input socket appears on the main body. The power supply module is correspondingly disposed in the circuit space of the main body and electrically connected to the power input socket. The power supply module converts alternating current of the electrical grid into direct current and is electrically connected to the power supply output wires to selectively output power from the power input socket or output backup power when the electrical grid is interrupted. The battery module is correspondingly disposed in the circuit space of the main body and electrically connected to the power supply module, such that the power supply module outputs power as the backup power from the battery module. In addition, the charging circuit module is correspondingly disposed in the circuit space of the main body and electrically connected to the battery module and the power supply module to charge the battery module.

Preferably, the main body is rectangular. The power input socket is disposed to a rear end of the main body. The power supply module is a circuit motherboard. The power supply module is narrowly rectangular. The power supply module is adjoined to the power input socket. The battery module includes a plurality of rectangular batteries. The battery module is longitudinally arranged along the circuit space of the main body.

The power supply device with the backup power in accordance with the present invention utilizes the integration of circuit elements to effectively combine the battery module as the backup power when the power is interrupted and the power supply device. In this way, the user does not need to simultaneously purchase a power supply device and an additional UPS system in the conventional technique. It does not only save the space allocation, but also greatly reduces costs. Moreover, the invention performs a design on the structure to form a rectangle. Accordingly, the effect of reducing spaces can be achieved to facilitate the allocation in the system case, thereby reducing the whole volume of the case.

### BRIEF DESCRIPTION OF THE DRAWINGS

FIG. 1 is an appearance view of a partial element of a power supply device with backup power in accordance with the present invention;

FIG. 2 is a schematic view of the disposition of a power supply device with backup power in accordance with the present invention;

FIG. 3 is a perspective view of an appearance of a power supply device with backup power in accordance with the present invention; and

FIG. 4 is an exploded view of a partial element appearance of a power supply device with backup power in accordance with the present invention.

### DETAILED DESCRIPTION OF THE PREFERRED EMBODIMENTS

The foregoing and other technical characteristics of the present invention will become apparent with the detailed description of the preferred embodiments and the illustration of the related drawings. It is noteworthy to point out that the drawings are provided for the purpose of illustrating the present invention, but they are not necessarily drawn according to the actual scale, or are intended for limiting the scope of the invention.

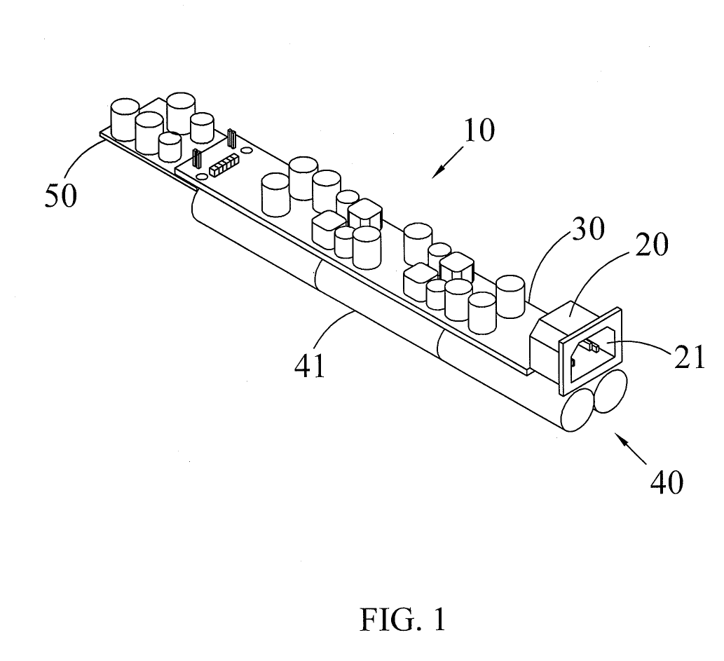

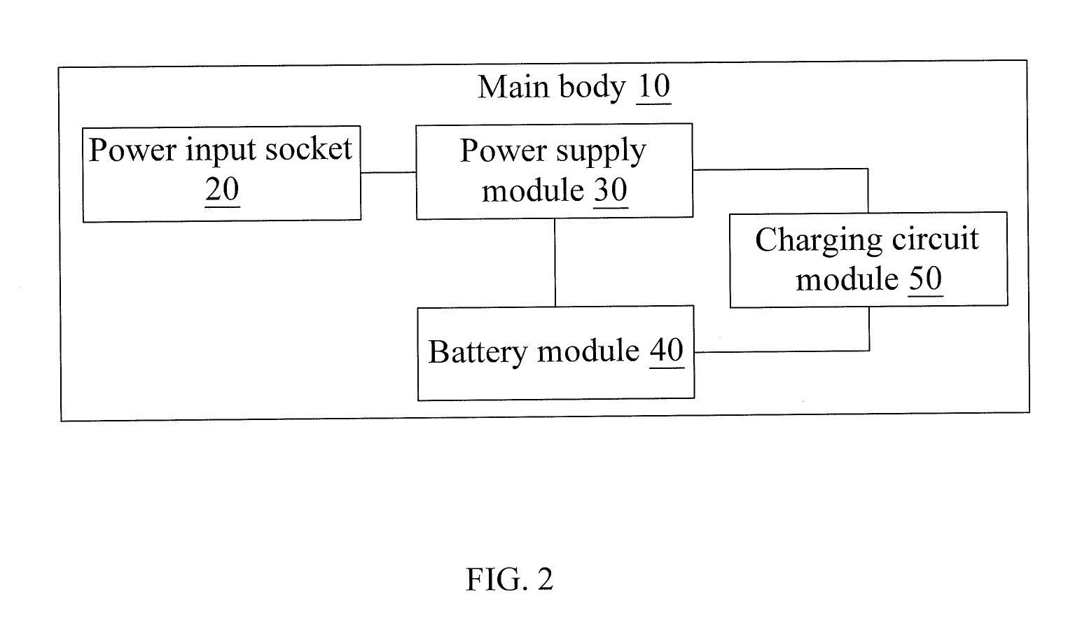

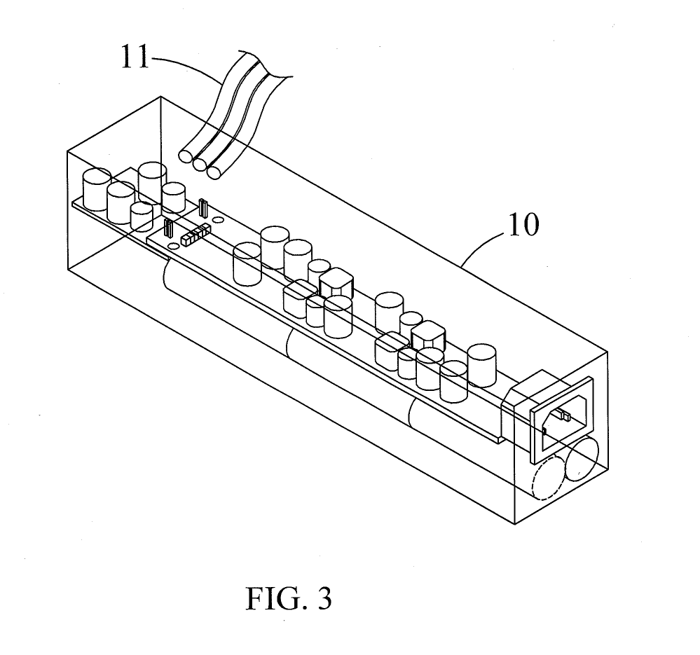

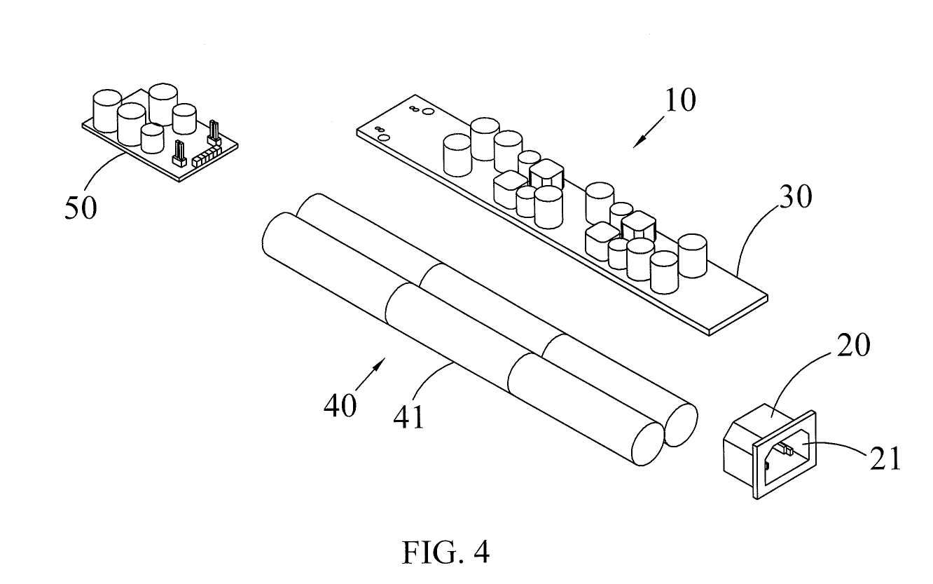

With reference to FIG. 1 to FIG. 4 for a power supply device with backup power in accordance with the present invention, which includes a main body 10, a power input socket 20, a power supply module 30, a battery module 40 and a charging circuit module 50.

The main body 10 is a case having a circuit space therein, wherein the structure can be a rectangle to achieve the function of saving spaces. A plurality of power supply output wires 11 may further protrude out from the main body 10, which connect to components such as a circuit board corresponding to a system mainframe, thereby charging power.

The power input socket 20 is a connection socket capable of being plugged with a power line to further be fed with alternating current of an electrical grid by using a plug. The power input socket 20 is correspondingly disposed on the main body 10, and a slot 21 on the power input socket 20 appears on the main body 10. The power input socket 20 can be disposed at a rear end of the main body 10.

The power supply module 30 can be a circuit main board or can be narrowly rectangular. The power supply module 30 is correspondingly disposed in the circuit space of the main body 10, and can be adjoined to the power input socket 20 and electrically connected to the power input socket 20. The power supply module 30 has a function of converting alternating current into direct current, and is electrically connected to the power supply output wires 11 to provide power from the power input socket 20. In addition, backup power can be outputted when the electrical grid is interrupted.

The battery module 40 is correspondingly disposed in the circuit space of the main body 10 and electrically connected to the power supply module 30, such that the power supply module 30 may output power as the backup power from the battery module 40. The battery module 40 can be a plurality of rectangular batteries 41 and can be longitudinally arranged along the circuit space of the main body 10.

The charging circuit module 50 is correspondingly disposed in the circuit space of the main body 10 and electrically connected to the battery module 40 and the power supply module 30. Accordingly, the power supply module 30 may feed the battery module 40 with the power originally sourced from the electrical grid.

With the variation of design of the power supply device with backup power according to the present invention, the battery module 40 taken as backup power when the power is interrupted and the power supply device can be effectively combined by integrating circuit elements. Therefore, the user does not need to simultaneously purchase a power supply device and an additional UPS system as in the conventional technique. It does not only save the space allocation, but also greatly reduces costs. Moreover, the invention performs a design on the structure to be rectangular. Accordingly, the effects of reducing space can be achieved to facilitate the allocation in the system case, thereby reducing the whole volume of the case.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A power supply device with backup power comprising:
a main body, being a case having a circuit space therein, and the main body being further disposed with a plurality of power supply output wires;
a power input socket, being a connection socket for being plugged with a power line to allow a plug of the power line to be fed with alternating current of an electrical grid, the power input socket correspondingly disposed on the main body, and a slot of the power input socket appearing on the main body;
a power supply module, correspondingly disposed in the circuit space of the main body and electrically connected to the power input socket, the power supply module converting alternating current of the electrical grid into direct current and electrically connected to the power supply output wires to selectively output power from the power input socket or output the backup power when the electrical grid being interrupted;
a battery module, correspondingly disposed in the circuit space of the main body and electrically connected to the power supply module, such that the power supply module outputs power as the backup power from the battery module; and
a charging circuit module, correspondingly disposed in the circuit space of the main body and electrically connected to the battery module and the power supply module to charge the battery module.

2. The power supply device with backup power as recited in claim 1, wherein the main body is rectangular.

3. The power supply device with backup power as recited in claim 2, wherein the power input socket is disposed to a rear end of the main body.

4. The power supply device with backup power as recited in claim 3, wherein the power supply module is a circuit motherboard.

5. The power supply device with backup power as recited in claim 4, wherein the power supply module is narrowly rectangular.

6. The power supply device with backup power as recited in claim 5, wherein the power supply module is adjoined to the power input socket.

7. The power supply device with backup power as recited in claim 6, wherein the battery module includes a plurality of rectangular batteries.

8. The power supply device having backup power as recited in claim 7, wherein the battery module is longitudinally arranged along the circuit space of the main body.
